(19) United States
(12) Patent Application Publication
(10) Pub. No.: US 2025/0303880 A1
(43) Pub. Date: Oct. 2, 2025

(54) DRIVE SYSTEM

(71) Applicant: HONDA MOTOR CO., LTD., Tokyo (JP)

(72) Inventors: Somei Nakatomi, Wako-shi (JP); Yoshihisa Kubota, Wako-shi (JP)

(21) Appl. No.: 19/058,047

(22) Filed: Feb. 20, 2025

(30) Foreign Application Priority Data
Mar. 27, 2024 (JP) 2024-052050

(51) Int. Cl. B60L 50/16; B60L 3/00

(52) U.S. Cl. CPC B60L 50/16; B60L 3/003; B60L 3/0046; B60L 3/0061

(57) ABSTRACT

A drive system of an electric vehicle drives, by electric power of a battery, a travel motor including a plurality of phases having a first coil group and a second coil group which include a common teeth portion. The drive system includes: a drive circuit that includes a first inverter which is connected to the first coil group and a second inverter which is connected to the second coil group in each phase of the travel motor; and a control portion that performs a discharging control which causes the first coil group and the second coil group that are in phase to generate a magnetic flux in an opposite direction to each other by controlling at least one of a connection state between the first inverter and the first coil group and a connection state between the second inverter and the second coil group in a state where the battery is electrically separated from a condenser that is connected in parallel between positive and negative electrodes of the battery when there is a discharging request of the condenser.

### CROSS-REFERENCE TO RELATED APPLICATION

Priority is claimed on Japanese Patent Application No. 2024-052050, filed on Mar. 27, 2024, the contents of which are incorporated herein by reference.

### BACKGROUND

### Field of the Invention

The present invention relates to a drive system.

### Background

In the related art, a system that drives a motor such as a travel motor of an electric vehicle has been proposed (for example, refer to Japanese Unexamined Patent Application, First Publication No. 2011-259570).

### SUMMARY

In this context, in the related art, in order to discharge electric power stored in a condenser provided on a drive circuit, techniques have been proposed such as a technique in which the electric power is consumed as heat by connecting a resistor to the condenser or a technique in which the electric power is consumed by a coil of a motor by controlling a d-axis current in the motor of a vector control. However, when connecting the resistor, a problem occurs in which the number of components or the component size increases, and when the motor is controlled by the vector control, a problem occurs in which a current sensor or a high-performance computer is required. That is, according to the related art, it is difficult to realize a discharging control from the condenser with a simple circuit configuration.

An aspect of the present invention aims at providing a drive system capable of performing a discharging control from a condenser with a simple circuit configuration.

An aspect of the present invention is a drive system of an electric vehicle that drives, by electric power of a battery, a travel motor including a plurality of phases having a first coil group and a second coil group which include a common teeth portion, the drive system including: a drive circuit that includes a first inverter which is connected to the first coil group and a second inverter which is connected to the second coil group in each phase of the travel motor; and a control portion that performs a discharging control which causes the first coil group and the second coil group that are in phase to generate a magnetic flux in an opposite direction to each other by controlling at least one of a connection state between the first inverter and the first coil group and a connection state between the second inverter and the second coil group in a state where the battery is electrically separated from a condenser that is connected in parallel between positive and negative electrodes of the battery when there is a discharging request of the condenser.

According to the aspect of the present invention, it is possible to perform the discharging control from the condenser with a simple circuit configuration.

### BRIEF DESCRIPTION OF THE DRAWINGS

FIG. 1 is a view showing an example of the configuration of a drive system of the present embodiment.

FIG. 2 is a view schematically showing the configuration of a magnetic circuit of a travel motor of the present embodiment.

FIG. 3 is a view schematically showing the configuration of a phase of a coil of the travel motor of the present embodiment.

FIG. 4 is a view showing an example of the configuration of a drive circuit of the present embodiment.

FIG. 5 is a view showing an example of a flow of an operation of a control device of the present embodiment.

FIG. 6 is a view showing an example of a reverse-phase discharging control by a control portion of the present embodiment.

FIG. 7 is a view showing an example of a current path in the reverse-phase discharging control of the present embodiment.

FIG. 8 is a view showing a modification example of the configuration of a drive system of the present embodiment.

### DESCRIPTION OF EMBODIMENTS

### [Overall Configuration of Drive System]

Hereinafter, an embodiment of the present invention will be described with reference to the drawings.

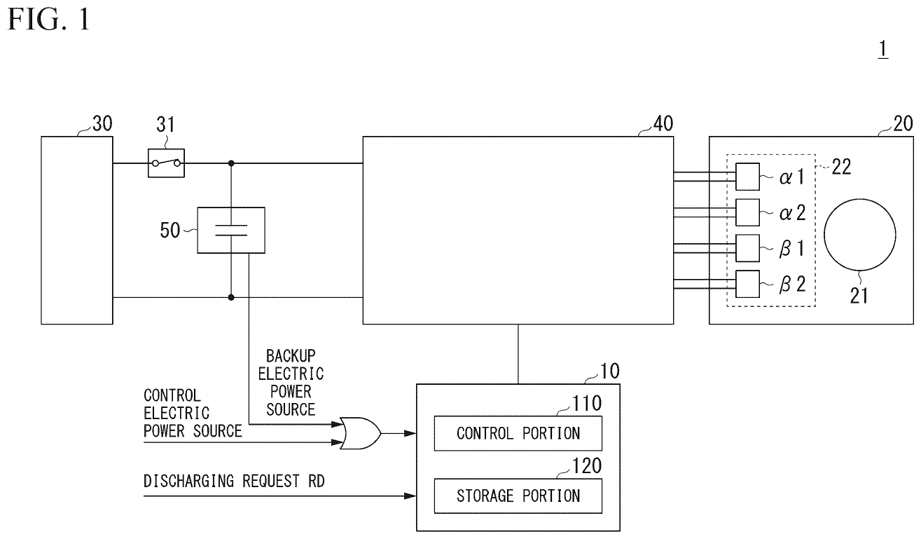

FIG. 1 is a view showing an example of the configuration of a drive system 1 of the present embodiment. In an example of the present embodiment, the drive system 1 is applied to an electric vehicle.

The drive system 1 includes a control device 10, a travel motor 20, a battery 30, and drive circuit 40.

The control device 10 includes a control portion 110 and a storage portion 120.

The control portion 110 includes, for example, a CPU (central processing unit) and and provides various functions on the basis of a program and data stored in the storage portion 120.

The storage portion 120 includes a storage element such as a non-volatile semiconductor memory and stores a program or data for an operation by the control portion 110.

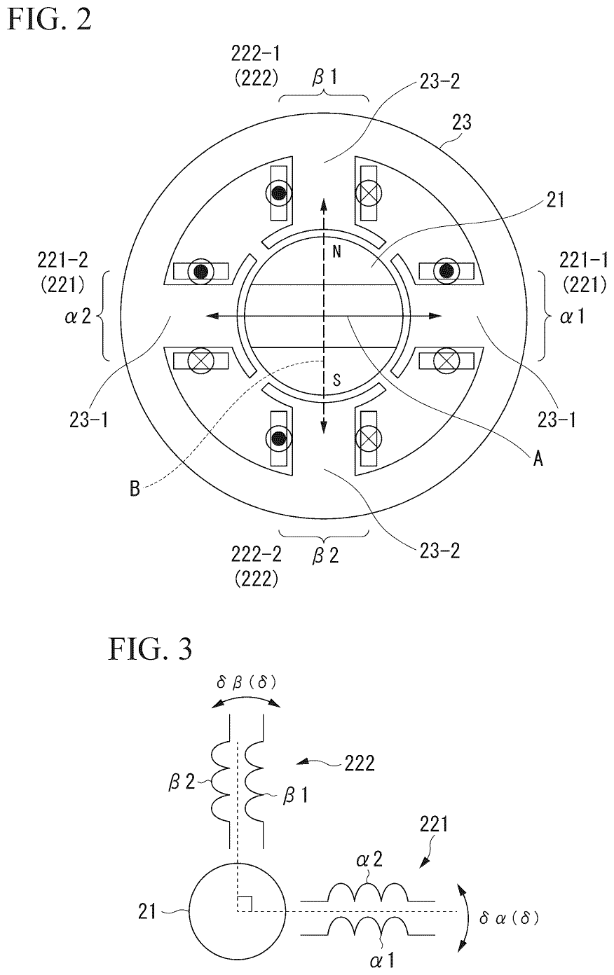

The travel motor 20 includes a rotor 21, a coil 22, and a stator 23 and is driven on the basis of a control of the control device 10. A specific example of a configuration of the travel motor 20 is described with reference to FIG. 2.

FIG. 2 is a view schematically showing the configuration of a magnetic circuit of the travel motor 20 of the present embodiment.

In the present embodiment, the travel motor 20 is a so-called two-phase open-winding switching motor. In an example of the present embodiment, the travel motor 20 is constituted of a two-phase coil 22 of an α-phase and a β-phase in which phases are displaced by 90 degrees from each other.

In the travel motor 20, a first coil group L1 and a second coil group L2 are wound around a teeth portion 23 of a phase. Specific examples of the first coil group L1 and the second coil group L2 are described.

The stator 23 includes an α-phase teeth portion 23-1 and a β-phase teeth portion 23-2.

An α-phase coil 221-1 (coil α1) and an α-phase coil 221-2 (coil α2) are wound around the α-phase teeth portion 23-1.

The α-phase coil 221-1 (coil α1) is also referred to as an α-phase first coil group L1. The α-phase coil 221-2 (coil α2) is also referred to as an α-phase second coil group L2.

A β-phase coil 222-1 (coil β1) and a β-phase coil 222-2 (coil β2) are wound around the β-phase teeth portion 23-2.

The β-phase coil 222-1 (coil β1) is also referred to as a β-phase first coil group L1. The β-phase coil 222-2 (coil β2) is also referred to as a β-phase second coil group L2.

That is, the travel motor 20 includes a plurality of phases having the first coil group L1 and the second coil group L2 which include a common teeth portion.

The α-phase coil 221-1 (coil α1) and the α-phase coil 221-2 (coil α2) generate a magnetic flux in a A-direction of FIG. 2. The β-phase coil 222-1 (coil β1) and the β-phase coil 222-2 (coil β2) generate a magnetic flux in a B-direction of FIG. 2. The A-direction and the B-direction are orthogonal to each other.

The travel motor 20 of the present embodiment is a so-called two-phase motor (or, also referred to as a spatial-phase orthogonal motor). In the travel motor 20, the α-phase coil 221-1 (coil α1) and the α-phase coil 221-2 (coil α2) are wound around a common teeth portion 23 (α-phase teeth portion 23-1) and are magnetically coupled to each other. The β-phase coil 222-1 (coil β1) and the β-phase coil 222-2 (coil β2) are wound around a common teeth portion 23 (β-phase teeth portion 23-2) and are magnetically coupled to each other.

In the travel motor 20, since a generation direction (the A-direction of FIG. 2) of the magnetic flux of the α-phase and a generation direction (the B-direction of FIG. 2) of the magnetic flux of the β-phase are orthogonal to each other, the phases do not magnetically interfere with each other.

Further, in the travel motor 20, each coil 22 is a so-called open winding. Accordingly, the travel motor 20 can switch an electric coupling state between the coils 22 by a switching circuit at the outside of the travel motor 20.

For example, the α-phase coil 221-1 (coil α1) and the α-phase coil 221-2 (coil α2) can be connected in series or in parallel with each other.

Similarly, the β-phase coil 222-1 (coil β1) and the β-phase coil 222-2 (coil β2) can be connected in series or in parallel with each other.

That is, the travel motor 20 includes a plurality of phases having the first coil group L1 and the second coil group L2 capable of switching the connection state to any of a series connection in which the coil groups are connected in series with each other and a parallel connection in which the coil groups are connected in parallel with each other.

The first coil group L1 and the second coil group L2 are open windings in which a plurality of phases are connected to an inverter (drive circuit 40) independently of each other.

According to the travel motor 20 having a configuration described above, since it is possible to individually control a current of each phase, it is possible to perform a control in consideration of overheating of a particular phase or the like.

FIG. 3 is a view schematically showing the configuration of a phase of the coil 22 of the travel motor 20 of the present embodiment. As described above, the phase of the α-phase and the phase of the β-phase are orthogonal to each other. Here, a phase difference δ between coils 22 that are wound around the common stator 23 is described.

The phase difference δα between the α-phase coil 221-1 (coil α1) and the α-phase coil 221-2 (coil α2) is 0 (zero). Similarly, the phase difference δβ between the β-phase coil 222-1 (coil β1) and the β-phase coil 222-2 (coil β2) is 0 (zero).

Accordingly, when causing a current having the same amplitude to flow through the α-phase coil 221-1 (coil α1) and the α-phase coil 221-2 (coil α2) so as to generate a magnetic flux in the opposite direction to each other, the magnetic fluxes cancel each other out, and the entire magnetic flux of the α-phase teeth portion 23-1 becomes 0 (zero).

Similarly, when causing a current having the same amplitude to flow through the β-phase coil 222-1 (coil β1) and the β-phase coil 222-2 (coil β2) so as to generate a magnetic flux in the opposite direction to each other, the magnetic fluxes cancel each other out, and the entire magnetic flux of the β-phase teeth portion 23-2 becomes 0 (zero).

With reference back to FIG. 1, in the travel motor 20, each of four types of coils 22 which are the α-phase coil 221-1 (coil α1), the α-phase coil 221-2 (coil α2), the β-phase coil 222-1 (coil β1), and the β-phase coil 222-2 (coil β2) is configured as an open winding.

The battery 30 includes a secondary battery or the like and supplies electric power for traveling to the travel motor 20.

A condenser 50 is connected in parallel with the battery 30 between a positive electrode and a negative electrode of the battery 30 and temporarily stores the electric power generated between the positive electrode and the negative electrode of the battery 30.

That is, the condenser 50 is connected in parallel between the positive and negative electrodes of the battery 30.

A battery contactor 31 is provided between the battery 30 and the condenser 50. The battery contactor 31 cuts off the supply of the electric power from the battery 30 on the basis of a control of a high-order system (not shown). That is, the battery contactor 31 cuts off the electrical connection between the battery 30 and the condenser 50.

As an example, the high-order system cuts off the battery contactor 31 at the time of control stopping (for example, when a control stop switch is operated by a driver) of an electric vehicle on which the drive system 1 is mounted, at the time of maintenance of a high-voltage electric system such as the battery 30, the drive circuit 40, or the travel motor 20, at the time of occurrence of an accident such as a collision, or the like.

When the battery contactor 31 is in a conduction state (ON state), the potential difference between both electrodes of the condenser 50 is equal to the voltage between the positive and negative electrodes of the battery 30. In the following description, the voltage between the positive and negative electrodes of the battery 30 is also referred to as a battery voltage VBatt.

Further, a battery voltage VBatt when the battery contactor 31 is cut off is also referred to as a final battery voltage VBattf. That is, the voltage between both electrodes of the condenser 50 immediately after the battery contactor 31 is cut off is equal to the final battery voltage VBattf.

The drive circuit 40 is connected to each coil 22 formed of the open winding of the travel motor 20. The drive circuit 40 controls the connection state of the coil 22 and the transfer of electric power between the battery 30 and the travel motor 20 on the basis of the control of the control device 10.

More specifically, the drive circuit 40 changes the connection state between the α-phase coil 221-1 (coil α1) and the α-phase coil 221-2 (coil α2) and the connection state between the β-phase coil 222-1 (coil β1) and the β-phase coil 222-2 (coil β2) to the series connection or the parallel connection. The drive circuit 40 supplies electric power supplied from the battery 30 to the travel motor 20 or supplies electric power generated by the travel motor 20 to the battery 30 (for example, regeneration) on the basis of the control of the control device 10.

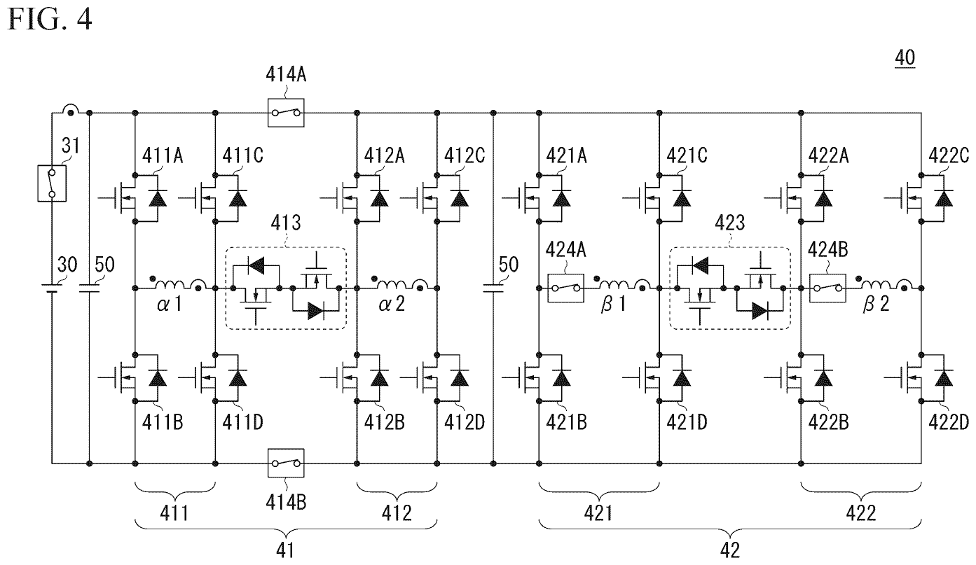

A specific example of the configuration of the drive circuit 40 is described with reference to FIG. 4.

FIG. 4 is a view showing an example of a configuration of the drive circuit 40 of the present embodiment. The drive circuit 40 includes a first inverter 41 and a second inverter 42.

The first inverter 41 is connected to the α-phase coil 221. The second inverter 42 is connected to the β-phase coil 222.

The first inverter 41 includes an eleventh inverter 411 and a twelfth inverter 412.

The eleventh inverter 411 includes a first switch 411A, a second switch 411B, a third switch 411C, and a fourth switch 411D that are constituted as an H-bridge and drives the α-phase coil 221-1 (coil α1).

The twelfth inverter 412 includes a first switch 412A, a second switch 412B, a third switch 412C, and a fourth switch 412D that are constituted as an H-bridge and drives the α-phase coil 221-2 (coil α2).

As described above, the α-phase coil 221-1 (coil α1) is the first coil group L1, and the α-phase second coil 221-2 (coil α2) is the second coil group L2.

In the β-phase, similarly, the second inverter 42 includes a twenty-first inverter 421 and a twenty-second inverter 422.

The twenty-first inverter 421 includes a first switch 421A, a second switch 421B, a third switch 421C, and a fourth switch 421D that are constituted as an H-bridge and drives the β-phase coil 222-1 (coil β1).

The twenty-second inverter 422 includes a first switch 422A, a second switch 422B, a third switch 422C, and a fourth switch 422D that are constituted as an H-bridge and drives the β-phase coil 222-2 (coil β2).

As described above, the β-phase coil 222-1 (coil β1) is the first coil group L1, and the β-phase coil 222-2 (coil β2) is the second coil group L2.

That is, the drive circuit 40 includes a first inverter (for example, the eleventh inverter 411 or the twenty-first inverter 421) that is connected to the first coil group L1 and a second inverter (for example, the twelfth inverter 412 or the twenty-second inverter 422) that are connected to the second coil group L2 in each phase of the travel motor 20.

### [Switch of Connection State of Coil 22]

The first connection changeover switch 413 is arranged between the eleventh inverter 411 and the twelfth inverter 412. The first connection changeover switch 413 is switched between an ON state and an OFF state on the basis of the control of the control device 10 and thereby switches the connection state between the α-phase coil 221-1 (coil α1) and the α-phase coil 221-2 (coil α2) to any one of the parallel connection and the series connection.

### (1) When Setting the Connection State of the Coil 22 to the Parallel Connection

The control device 10 sets the first connection changeover switch 413 to be in an OFF state. When the first connection changeover switch 413 is in the OFF state, the eleventh inverter 411 and the twelfth inverter 412 are electrically separated from each other. As a result, the eleventh inverter 411 drives the α-phase coil 221-1 (coil α1). The twelfth inverter 412 drives the α-phase coil 221-2 (coil α2).

More specifically, the control device 10 sets the first switch 411A and the fourth switch 411D to be in the ON state and sets the second switch 411B and the third switch 411C to be in the OFF state with respect to the eleventh inverter 411. As a result, in the α-phase coil 221-1 (coil α1), a current path is formed between the first switch 411A and the fourth switch 411D.

The control device 10 sets the first switch 412A and the fourth switch 412D to be in the ON state and sets the second switch 412B and the third switch 412C to be in the OFF state with respect to the twelfth inverter 412. As a result, in the α-phase coil 221-2 (coil α2), a current path is formed between the first switch 412A and the fourth switch 412D.

When electric power is supplied to the travel motor 20 from the battery 30 or the condenser 50, with respect to the eleventh inverter 411, a drive current flows through the α-phase coil 221-1 (coil α1) in a direction from the first switch 411A toward the fourth switch 411D. With respect to the twelfth inverter 412, similarly, a drive current flows through the α-phase coil 221-2 (coil α2) in a direction from the first switch 412A toward the fourth switch 412D.

As shown in FIG. 4, in the α-phase coil 221-1 (coil α1), an end portion that is connected to the first switch 411A is denoted by a black circle. In the α-phase coil 221-2 (coil α2), an end portion that is connected to the first switch 412A is denoted by a black circle.

When the drive current flows from the side of the black circle attached to the coil 22, the direction of the magnetic flux generated in the α-phase teeth portion 23-1 by the drive current that flows through the α-phase coil 221-1 (coil α1) and the direction of the magnetic flux generated in the α-phase teeth portion 23-1 by the drive current that flows through the α-phase coil 221-2 (coil α2) are matched with each other.

That is, the α-phase coil 221-1 (coil α1) and the α-phase coil 221-2 (coil α2) generate the magnetic flux in the same direction in the stator 23.

When the direction of the drive current that flows through the α-phase coil 221-1 (coil α1) and the α-phase coil 221-2 (coil α2) is set to a reverse direction, the control device 10 reverses the ON state/the OFF state of each switch of the eleventh inverter 411 and the twelfth inverter 412 from the state described above.

As described above, the control device 10 sets the α-phase coil 221-1 (coil α1) and the α-phase coil 221-2 (coil α2) to be in the parallel connection and controls the drive current.

Since the structure of the parallel connection of the coil 22 in the second inverter 42 is similar to that of the first inverter 41 except for the operation in a phase displaced by 90 degrees with respect to the first inverter 41, descriptions thereof are omitted.

### (2) When Setting the Connection State of the Coil 22 to the Series Connection

The control device 10 sets the first connection changeover switch 413 to be in an ON state and sets all of the third switch 411C and the fourth switch 411D of the eleventh inverter 411 and the first switch 412A and the second switch 412B of the twelfth inverter 412 to be in an OFF state.

When the first connection changeover switch 413 is in the ON state, the eleventh inverter 411 and the twelfth inverter 412 are electrically connected.

As a result, the first inverter 41 constitutes an H-bridge by the first switch 411A, the second switch 411B, the third switch 412C, and the fourth switch 412D.

The control device 10 switches the ON state/the OFF state by setting the first switch 411A and the fourth switch 412D to be a set and setting the second switch 411B and the third switch 412C to be a set. As a result, the α-phase coil 221-1 (coil α1) and the α-phase coil 221-2 (coil α2) are driven in a state where the coils are connected in series.

### [Function of Charging Mode]

Here, in a so-called plug-in electric vehicle, the case in which the first inverter 41 and the second inverter 42 are utilized as a charging circuit at the time of charging of the battery 30 by an external charger (not shown) is described.

In general, the charging circuit that is connected to the external charger includes a reactor for adjusting a voltage, a switching element, and an isolation transformer.

As described above, since the travel motor 20 of the present embodiment is constituted as a spatial-phase orthogonal and open winding, the α-phase and the β-phase are electrically separated and individually controlled, and thereby, it is possible to have a different function from each other between the phases.

For example, the travel motor 20 can cause the α-phase to function as an insulation transformer and cause the β-phase to function as a reactor.

The drive circuit 40 of the present embodiment causes the coil 22 of the first inverter 41 to function as an insulation transformer and causes the coil 22 of the second inverter 42 to function as a reactor.

(1) When causing the coil 22 of the second inverter 42 to function as a reactor

The drive circuit 40 includes a disconnection switch 424 on the second inverter 42. The disconnection switch 424 includes a first disconnection switch 424A and a second disconnection switch 424B.

The first disconnection switch 424A is connected in series to the β-phase coil 222-1 (coil β1). The second disconnection switch 424B is connected in series to the β-phase coil 222-2 (coil β2).

When causing the coil 22 of the second inverter 42 to function as a reactor for charging, the control device 10 sets the disconnection switch 424 (the first disconnection switch 424A and the second disconnection switch 424B) to be in an OFF state. As a result, both of one end of the β-phase coil 222-1 (coil β1) and one end of the β-phase coil 222-2 (coil β2) are opened.

By connecting each phase of the external charger to one end of the coil 22 that is opened by the disconnection switch 424, it is possible to cause the β-phase coil 222-1 (coil β1) and the β-phase coil 222-2 (coil β2) to function as a reactor for charging.

As an example, the U-phase of the external charger is connected to one end of the-phase coil 222-1 (coil β1), the V-phase of the external charger is connected to a neutral point of a second connection changeover switch 423, and the W-phase of the external charger is connected to one end of the β-phase coil 222-2 (coil β2) by a charger connection circuit (not shown).

In this case, each switching element of the second inverter 42 functions as an inverter that converts the electric power supplied from the external charger to a charging current of the battery 30.

### (2) When Causing the Coil 22 of the First Inverter 41 to Function as an Isolation Transformer

When charging the electric power supplied from the external charger to the battery 30, it is preferable that the external charger (not shown) is electrically insulated from the battery 30.

For example, when the external charger is connected to the second inverter 42 side, if the insulation transformer is arranged between the second inverter 42 and the battery 30, the second inverter 42 and the battery 30 can be electrically insulated from each other.

When performing charging from the external charger, the drive system 1 causes the first inverter 41 to function as an insulation transformer.

The drive circuit 40 includes a disconnection switch 414 on the first inverter 41. The disconnection switch 414 includes a first disconnection switch 414A and a second disconnection switch 414B. The first disconnection switch 414A is arranged on a positive electrode side (high potential side) of the battery 30 in electric power source wirings between the eleventh inverter 411 and the twelfth inverter 412. The second disconnection switch 414B is arranged on a negative electrode side (low potential side) of the battery 30 in the electric power source wirings between the eleventh inverter 411 and the twelfth inverter 412.

When causing the coil 22 of the first inverter 41 to function as an isolation transformer, the control device 10 sets the disconnection switch 414 (the first disconnection switch 414A and the second disconnection switch 414B) to be in an OFF state. As a result, the electric power source wiring of the eleventh inverter 411 and the electric power source wiring of the twelfth inverter 412 are insulated from each other.

As described above, the α-phase coil 221-1 (coil α1) and the α-phase coil 221-2 (coil α2) are wound around the common teeth portion 23 (the α-phase teeth portion 23-1) and are magnetically coupled to each other. Therefore, the AC electric power supplied to the twelfth inverter 412 from the external charger that is connected to the second inverter 42 side is transmitted from the α-phase coil 221-2 (coil α2) to the α-phase coil 221-1 (coil α1) via the magnetic coupling. As a result, the electric power that is transmitted to the α-phase coil 221-1 (coil α1) is charged to the battery 30.

That is, the first inverter 41 functions as an insulation transformer and transmits the electric power by the magnetic coupling while electrically insulating the second inverter 42 side and the battery 30 from each other.

As described above, the first inverter 41 and the second inverter 42 of the present embodiment function as a circuit for driving of the travel motor 20 and function as a circuit for charging of the battery 30 when the external charger is connected.

That is, according to the drive circuit 40 of the present embodiment, it is possible to serve as a reactor for charging, an inverter, and an insulation transformer, and therefore, as compared with the case where these functions are constituted by a dedicated circuit for charging, it is possible to reduce the number of components and reduce the weight and costs.

### [Discharging Control by Control Device 10]

Next, a discharging control by the control device 10 is described. The control device 10 of the present embodiment controls the travel motor 20 on the basis of a request from a high-order system (for example, a power plant control system) of the electric vehicle. As an example, the request from the high-order system includes a discharging request RD. The discharging request RD is a command to the control device 10 for discharging the electric power stored in the condenser 50 in a state where the battery contactor 31 is cut off.

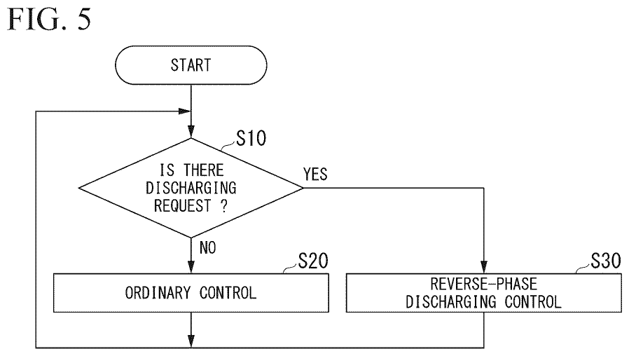

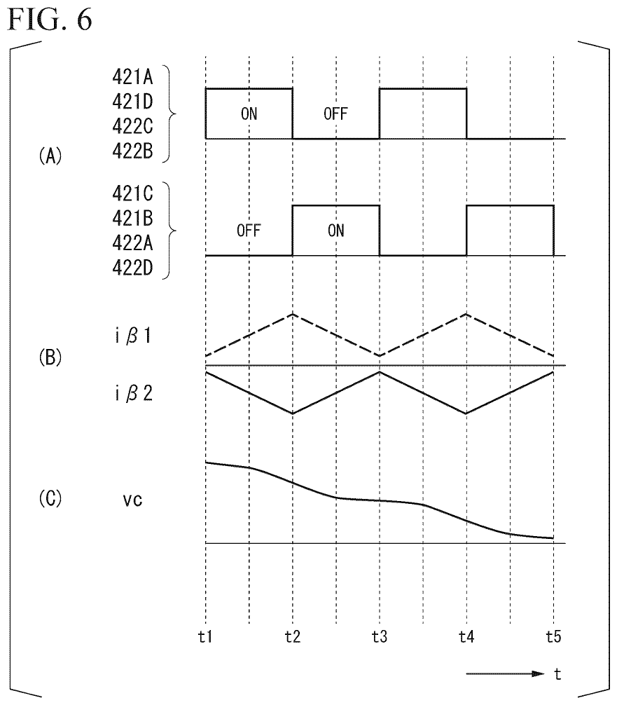

An example of a flow of an operation of a discharging control of the control device 10 is described with reference to FIG. 5.

FIG. 5 is a view showing an example of a flow of an operation of a control device of the present embodiment.

FIG. 5 is a view showing an example of a flow of an operation of the control device 10 of the present embodiment.

(Step S10) A control portion 110 of the control device 10 determines whether or not there is a discharging request RD from the high-order system. When the control portion 110 determines that there is no discharging request RD (Step S10; NO), the process proceeds to Step S20.

(Step S20) When there is no discharging request RD, the control portion 110 performs an ordinary control.

Here, the ordinary control refers to a general control other than the discharging control. The control portion 110 causes the process to return to Step S10 and continues the determination of the presence or absence of the discharging request RD.

On the other hand, in Step S10, when the control portion 110 determines that there is a discharging request RD (Step S10; YES), the process proceeds to Step S30.

(Step S30) When there is a discharging request RD, the control portion 110 performs a discharging control. The discharging control performed by the control portion 110 of the present embodiment is also referred to as a reverse-phase discharging control. An example of the reverse-phase discharging control is shown in FIG. 6.

FIG. 6 is a view showing an example of a reverse-phase discharging control by the control portion 110 of the present embodiment. The control portion 110 sets the coil 22 of the second inverter 42 to be in a state of the parallel connection. The control portion 110 controls the ON state/the OFF state by setting the first switch 421A and the fourth switch 421D of the twenty-first inverter 421 and the third switch 422C and the second switch 422B of the twenty-second inverter 422 to be a set (also referred to as a first set). Further, the control portion 110 controls the ON state/the OFF state by setting the third switch 421C and the second switch 421B of the twenty-first inverter 421 and the first switch 422A and the fourth switch 422D of the twenty-second inverter 422 to be a set (also referred to as a second set).

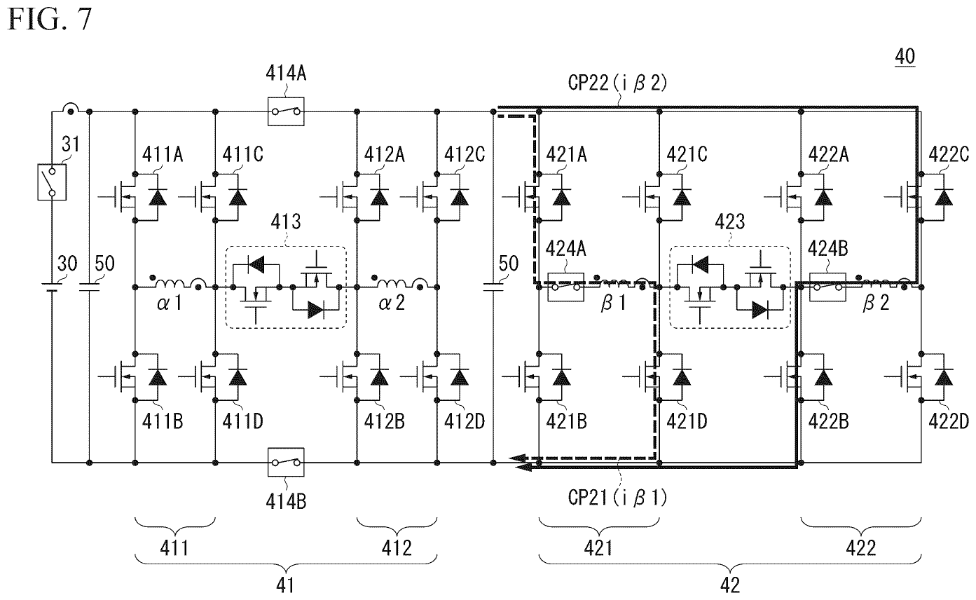

As shown in a portion [A] of FIG. 6, the control portion 110 controls the ON state/the OFF state of the first set and the second set described above in reverse. As a result, a current path CP shown in FIG. 7 is formed.

FIG. 7 is a view showing an example of the current path CP in the reverse-phase discharging control of the present embodiment. FIG. 7 shows an example of the current path CP in the case (for example, a state between a time t1 and a time t2 in FIG. 6) where the first set described above is set to be in the ON state, and the second set described above is set to be in the OFF state.

In the example, a first current path CP21 and a second current path CP22 are formed by the reverse-phase discharging control.

As shown in a portion [B] of FIG. 6, when the first current path CP21 and the second current path CP22 are constituted, a first current iβ1 flows through the β-phase coil 222-1 (coil β1), and a second current iβ2 flows through the β-phase coil 222-2 (coil β2). The first current iβ1 and the second current iβ2 flow, and thereby, electric power consumption by a copper loss of a circuit or a switching loss occurs.

As described above, in the discharging control (reverse-phase discharging control), since the battery contactor 31 is cut off, there is no supply of electric power from the battery 30. Therefore, the electric power of the condenser 50 is consumed, and as shown in a portion [C] of FIG. 6, the voltage (that is, a condenser voltage vc) of both ends of the condenser 50 is decreased.

The direction of the first current iβ1 and the direction of the second current iβ2 are opposite directions to each other. As described above, the phase difference δβ between the β-phase coil 222-1 (coil β1) and the β-phase coil 222-2 (coil β2) is 0 (zero). Therefore, the magnetic fluxes generated by the currents that flow through the coils 22 cancel each other out, and a magnetic flux is not generated as the entire coil 22.

That is, the control portion 110 causes the first current iβ1 and the second current iβ2 to flow such that no magnetic flux is generated at the coil 22 (the β-phase coil 222-1 (coil β1) and the β-phase coil 222-2 (coil β2)) of the second inverter 42.

As described above, the α-phase coil 221-1 (coil α1) is the first coil group L1, and the α-phase coil 221-2 (coil α2) is the second coil group L2.

Further, the β-phase coil 222-1 (coil β1) is the first coil group L1, and the β-phase coil 222-2 (coil β2) is the second coil group L2.

That is, the drive system 1 performs a control such that a current flows in a reverse phase through the first coil group L1 and the second coil group L2 that are magnetically coupled. According to the drive system 1 having a configuration in this way, the magnetic fluxes generated by the coils 22 cancel each other out, and it is possible to perform the discharging of the high-voltage electric power source system (for example, the condenser 50) without generating a torque at the travel motor 20.

In general, in a configuration in which the travel motor 20 is controlled by the vector control, it is necessary to perform sensing of a rotation angle of the rotor 21 and a feedback calculation by the rotation angle obtained by the sensing. In this case, in order to prevent the travel motor 20 from generating a torque when the discharging control is performed, the feedback calculation by the rotation angle obtained by the sensing is essential.

On the other hand, the drive system 1 of the present embodiment, by using no vector control and by using a winding configuration and a magnetic design of the coil 22, it is possible to perform the discharging without generating the torque at the travel motor 20 only by controlling the direction of the discharging current.

In the example described above, the control portion 110 discharges the condenser 50 by operating the second inverter 42; however, the embodiment is not limited thereto. The control portion 110 may operate the first inverter 41 and discharge the condenser 50. Further, the control portion 110 may operate both of the first inverter 41 and the second inverter 42 and discharge the condenser 50.

That is, when there is a discharging request of the condenser 50, the control portion 110 performs a discharging control which causes the first coil group L1 and the second coil group L2 that are in phase to generate a magnetic flux in an opposite direction to each other by controlling each of the connection state between the first inverter (for example, the eleventh inverter 411 and the twenty-first inverter 421) and the first coil group L1 and the connection state between the second inverter (for example, the twelfth inverter 412 and the twenty-second inverter 422) and the second coil group L2.

As an example, the high-order system outputs the discharging request RD at the time of occurrence of an accident such as a collision or the like. For example, the discharging request is generated when a collision of an electric vehicle is detected.

According to the drive system 1 that performs the reverse-phase discharging control as described above, even when a sensor for the sensing of the rotation angle of the rotor 21 cannot be used due to an impact such as a collision, or a relatively high-performance computer required for the feedback calculation does not operate, it is possible to perform the discharging without generating a torque at the travel motor 20.

### [Configuration of Operation Electric Power Source of Control Device 10]

As shown in FIG. 1, the control device 10 can be operated by a backup electric power source using the electric power supplied from the condenser 50 in addition to a control electric power source (for example, a low voltage electric power source for a control supplied from a so-called 12V battery or the like) supplied from the high-order system.

That is, at least a circuit that performs the discharging control in the control portion 110 is operated by any of the electric power supplied from the control electric power source that drives another circuit of the control portion 110 and the electric power supplied from the condenser 50.

Further, the control portion 110 of the control device 10 may be constituted such that a circuit that performs a control which drives the travel motor 20 and a circuit that performs the discharging control (reverse-phase discharging control) are individual circuits.

In this case, the backup electric power source described above supplies electric power to at least the circuit that performs the discharging control (reverse-phase discharging control).

That is, at least the circuit that performs the discharging control in the control portion 110 is operable by the electric power supplied from the condenser 50. According to the drive system 1 having a configuration in this way, even when the electric power of the control electric power source supplied from the high-order system is lost by a failure, a collision accident, or the like, it is possible to continue at least the operation of the discharging control.

### MODIFICATION EXAMPLE

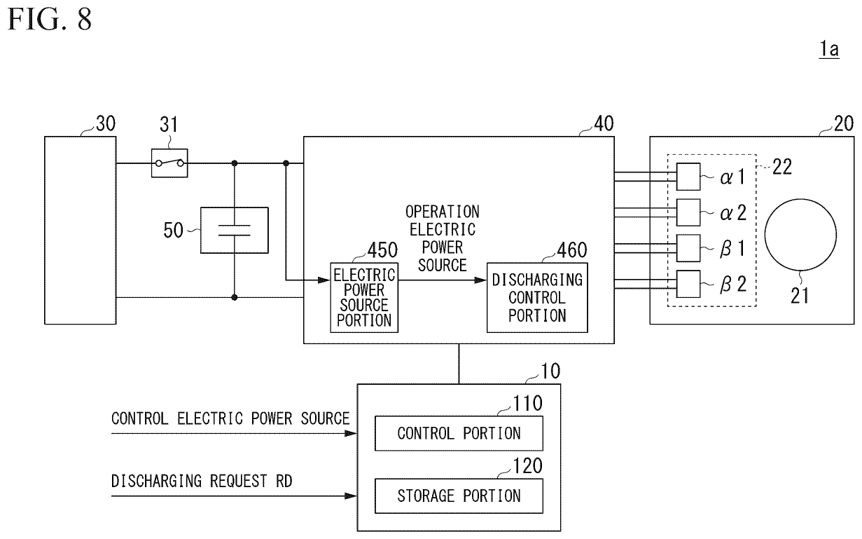

FIG. 8 is a view showing a modification example of the configuration of a drive system 1 of the present embodiment. In the embodiment described above, it is assumed that the drive circuit 40 and the control device 10 are constituted as an individual device. The above embodiment is described using an example in which the control portion 110 of the control device 10 performs the discharging control (reverse-phase discharging control); however, the embodiment is not limited thereto.

The present modification example differs from the configuration of the embodiment described above in that, in the functions of the control portion 110 described above, a discharging control portion 460 that performs at least the discharging control (reverse-phase discharging control) is provided on the drive circuit 40.

There may be cases in which a gate drive circuit of a transistor (for example, the first switch 421A to the fourth switch 422D) that constitutes the first inverter 41 and the second inverter 42 is formed on the drive circuit 40.

When the gate drive circuit is constituted in the drive circuit 40 in this way, the discharging control portion 460 that performs the discharging control (reverse-phase discharging control) may be integrated with the gate drive circuit.

Here, the term “integrated” refers to the case where the gate drive circuit and the circuit of the discharging control portion 460 are formed on the same board, or the case where the gate drive circuit and the circuit of the discharging control portion 460 are formed on separate boards, and the boards are connected together by a jumper line or a removable (or non-removable) stacking connector.

Further, the drive circuit 40 may be stored in a casing (housing) for waterproof, dust prevention, or strength improvement. In this case, the term “integrated” refers to the case where the gate drive circuit and the circuit of the discharging control portion 460 are formed in the same casing.

That is, at least the discharging control portion 460 that performs the discharging control in the control portion 110 described above is provided on the gate drive circuit of the transistor that constitutes the first inverter 41 and the second inverter 42 in an integrated manner.

In general, the control device 10 is constituted of a computer having a relatively high calculation performance since the control device 10 is required to perform a relatively complex calculation in order to drive the travel motor 20.

On the other hand, as described above, the discharging control (reverse-phase discharging control) effectively utilizes the spatial-phase orthogonal property of the coil 22 of the travel motor 20 in which the phase difference δ between the coils 22 of the phases is 0 (zero). That is, the discharging control (reverse-phase discharging control) enables the discharging of the condenser 50 while preventing a magnetic flux from being generated and preventing a torque from being generated at the travel motor 20 only by causing a current to flow through the coil 22 of the travel motor 20. That is, the discharging control (reverse-phase discharging control) can be realized by a relatively simple circuit that sets a predetermined switch of the first inverter 41 or the second inverter 42 to be in an ON state or an OFF state.

Accordingly, the discharging control portion 460 can be easily integrated with the gate drive circuit.

In the drive system 1 of the present modification example, since the discharging control portion 460 and the gate drive circuit of the transistor that constitutes the first inverter 41 and the second inverter 42 are integrated, even when a sensor for the sensing of the rotation angle of the rotor 21 cannot be used due to an impact such as a collision, or a relatively high-performance computer required for the feedback calculation does not operate, it is possible to perform the discharging without generating a torque at the travel motor 20.

While the embodiment of the present invention has been described in detail with reference to the drawings, a specific configuration is not limited to the embodiment, and changes can be appropriately made without departing from the scope of the present invention. The configurations described in the embodiment described above may be combined.

Each portion included in each device in the embodiment described above may be realized by dedicated hardware or may be realized by a memory and a microprocessor.

Each portion included in each device may be constituted of a memory and a CPU (central processing unit), and a program for realizing the function of each portion included in each device may be loaded in the memory and be executed to thereby realize the function.

What is claimed is:

1. A drive system of an electric vehicle that drives, by electric power of a battery, a travel motor comprising a plurality of phases having a first coil group and a second coil group which include a common teeth portion, the drive system comprising:
a drive circuit that comprises a first inverter which is connected to the first coil group and a second inverter which is connected to the second coil group in each phase of the travel motor; and
a control portion that performs a discharging control which causes the first coil group and the second coil group that are in phase to generate a magnetic flux in an opposite direction to each other by controlling at least one of a connection state between the first inverter and the first coil group and a connection state between the second inverter and the second coil group in a state where the battery is electrically separated from a condenser that is connected in parallel between positive and negative electrodes of the battery when there is a discharging request of the condenser.

2. The drive system according to claim 1,
wherein the first coil group and the second coil group are open windings in which a plurality of phases are connected to an inverter independently of each other.

3. The drive system according to claim 1,
wherein the discharging request is generated when a collision of the electric vehicle is detected.

4. The drive system according to claim 1,
wherein at least a circuit that performs the discharging control in the control portion is operable by electric power supplied from the condenser.

5. The drive system according to claim 4,
wherein at least a circuit that performs the discharging control in the control portion is operated by any of electric power supplied from a control electric power source that drives another circuit of the control portion and the electric power supplied from the condenser.

6. The drive system according to claim 1,
wherein at least a discharging control portion that performs the discharging control in the control portion is provided on a gate drive circuit of a transistor that constitutes the first inverter and the second inverter.
